(19) United States
(12) Patent Application Publication
(10) Pub. No.: US 2008/0139722 A1
(43) Pub. Date: Jun. 12, 2008

(54) VIBRATION DAMPING POLYMER COMPOSITES

(75) Inventors: Terri A. Shefelbine, Saint Paul, MN (US); James M. Nelson, Woodbury, MN (US); Dmitriy Salnikov, Woodbury, MN (US); Ryan E. Marx, Rosemount, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/952,192

(22) Filed: Dec. 7, 2007

Related U.S. Application Data
(60) Provisional application No. 60/869,245, filed on Dec. 8, 2006.

(51) Int. Cl. C08L 53/00; C08K 3/04; C08K 3/08; C08K 3/22; C08K 3/36

(52) U.S. Cl. 524/413; 524/431; 524/434; 524/437; 524/440; 524/493; 524/496

(57) ABSTRACT

Compositions comprising a carbon containing nano-material, a curable matrix, and a block copolymer comprising a functional block and a non-functional block, wherein no block is compatible with the curable matrix. Also provided are cured compositions, multi-layer articles comprising the compositions, and multi-layer articles comprising the cured compositions. Further provided is a method for increasing the material dampening of a polymer composition comprising mixing a curable matrix, a carbon containing nano-material, and a block copolymer comprising a functional block and a non-functional block.

### CROSS-REFERENCE TO RELATED APPLICATION

This application claims the benefit of U.S. Provisional patent Application No. 60/869,245, filed Dec. 8, 2006, the disclosure of which is incorporated by reference herein in its entirety.

### FIELD OF THE DISCLOSURE

This disclosure relates to polymer composites, cured compositions and multi-layer articles which in some embodiments may have useful vibration damping properties.

### SUMMARY

In one aspect, the present invention relates to a vibration damping composition comprising a carbon containing nano-material, a curable matrix, and a block copolymer comprising a functional block and a non-functional block, wherein no block is compatible with the curable matrix.

In yet another aspect, the present invention relates to a multilayer article comprising a vibration damping composition comprising a carbon containing nano-material, a curable matrix, and a block copolymer comprising a functional block and a non-functional block, wherein no block is compatible with the curable matrix.

In yet a further aspect, the present invention relates to a composition comprising a carbon containing nano-material, a thermosetting polymer, and a block copolymer comprising a functional block and a non-functional block, wherein no block is compatible with the thermosetting polymer.

In another aspect, the present invention relates to a composition comprising a carbon containing nano-materials, a viscoelastic polymer, and a block copolymer comprising a functional block and a non-functional block, wherein no block is compatible with the viscoelastic polymer.

As used herein, a block of a copolymer, for instance, block A in a block copolymer given by the general formula ABC, is considered as being compatible with the curable matrix if the polymer A identical to this block (i.e., without the B and C blocks) is compatible with the curable matrix. Similarly, block A is considered incompatible with the curable matrix if the polymer A identical to block A is incompatible with the curable matrix. In general, “compatibility between two polymers” means the ability of one to dissolve in the other, or alternatively, their total miscibility. In the opposite case, the polymers are said to be incompatible.

When mixing two distinct polymers, a negative value of the free energy of mixing indicates compatibility. For most polymers the unfavorable specific enthalpic interaction between the monomers cannot be overcome by the small change in the entropic state of the resulting blend. In certain cases, there is a favorable specific interaction between the monomers that is reflected by a negative heat of mixing for the corresponding polymers. In the context of the present invention, it is preferred to avoid block copolymers whose heat of mixing with the curable matrix is negative.

The heat of mixing, however, cannot be measured conventionally for all polymers, and thus the compatibility can only be determined indirectly. One indication of the compatibility of a mixture of polymers is the number of distinct phases the system has. Truly miscible polymers will have only one phase. A characteristic of mixtures with one phase is one single Tg value. Tg values can be measured by, for example measuring viscoelastic responses of a polymer blend or alternatively by differential calorimetric analysis. Mixtures of compatible polymers may display one or two glass transition temperature values (Tg). Where two separate Tg values are detected for a mixture containing compatible polymers, at least one of the two Tg values is different from the Tg values of the pure polymers and is in the range between the two Tg values of the pure polymers. The mixture of two totally miscible polymers has only one Tg value.

With respect to thermosets, for instance an epoxy, compatibility is measured in the final cured state of the thermoset. For instance, while a polymer may be compatible with an epoxy monomer, if a mixture of the polymer and epoxy polymer shows two distinct Tg values corresponding to the Tg values of the pure polymers (that is, the polymer of the block and the thermoset epoxy), the polymer and the epoxy polymer are considered to be not compatible.

Other experimental methods that may demonstrate the compatibility of polymers include turbidity measurements, light-scattering measurements, and infrared measurements.

### BRIEF DESCRIPTION OF THE DRAWINGS

FIGS. 1-7 are graphs demonstrating results of Dynamic Mechanical Thermal Analysis (DMTA) testing performed on compositions according to the present disclosure (EX compositions) and comparative compositions (CE compositions), as described in the Examples.

### DETAILED DESCRIPTION

The curable matrix is selected from elastomeric polymers, thermoplastic elastomeric polymers or thermoset polymers, each of which may be fluorinated or non-fluorinated.

Useful thermoset polymers include, generally, aminos, esters, furans, polyesters, phenolics, epoxies, polyurethanes, silicones, allyls, and cross-linkable thermoplastics. Phenolic thermoset polymers include phenol-formaldehyde, such as novolac phenol-formaldehyde resins and resole phenolic resins. Thermoset epoxy polymers include the diglycidyl ether of bisphenol A, glycidyl amines, novolacs, peracid resins, and hydantoin resins. Other examples of useful thermoset polymers include those described in “Handbook of Thermoset Plastics” by Goodman (2^{nd} ed., 1998).

Useful impact modifying rubbers include, for instance, thermoplastic elastomeric polymeric resins. Impact modifying rubbers may be selected from, for example, polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), nitrile-butadiene rubber (NBR), hydrogenated nitrile-butadiene rubber (HNBR), poly(butadiene-co-pentadiene), chlorosulfonated polyethylenes, polysulfide elastomers, block copolymers, made up of segments of glassy or crystalline blocks such as polystyrene, poly(vinyltoluene), poly(t-butylstyrene), polyester and the like and the elastomeric blocks such as polybutadiene, polyisoprene, ethylene-propylene copolymers, ethylene-butylene copolymers, polyether ester and the like as for example the copolymers in poly(styrene-butadiene-styrene) block copolymer manufactured by Shell Chemical Company under the trade name of “KRATON”.

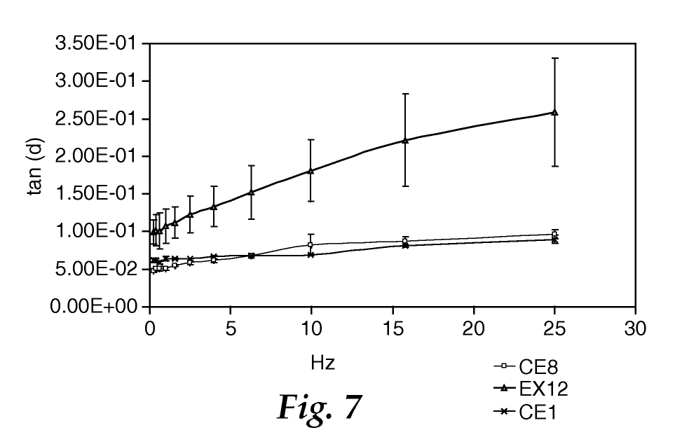

Copolymers and/or combinations or blends of these aforementioned polymers can also be used. For instance, a blend of a thermosetting polymer and an elastomeric polymer may be used. When such blends are used, the addition to a curable matrix of containing nano-materials and a block copolymer comprising a functional block and a non-functional block, wherein no block is compatible with the curable matrix can exhibit interesting results. For instance, shown in FIG. 7 is a DMTA at various temperatures. The curable matrix contains a continuous rubbery phase and a thermosetting polymer. At temperatures below the Tg of the rubbery phase, the compositions comprising carbon containing nano-materials and the block copolymers do not show improved damping properties at the frequency measured. Above the Tg of the rubbery phase, however, the damping properties of the compositions comprising a curable matrix, carbon containing nano-materials, and the block copolymers display improved damping properties over the curable matrix without these two additives.

Useful polymeric resins also include fluoropolymers, that is, at least partially fluorinated polymers. Useful fluoropolymers include, for example, those that are preparable (e.g., by free-radical polymerization) from monomers comprising chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example nitrile containing monomers (e.g., CF₂═CFO(CF₂) LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, or CF₂═CFO(CF₂)ᵤOCF(CF₃)CN where L=2-12; q=0-4; r=1-2; y=0-6; t=1-4; and u=2-6), bromine containing monomers (e.g., Z-R_{f}—Oₓ—CF═CF₂, wherein Z is Br or I, R_{f} is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; terpolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro(alkyl vinyl ether) copolymers (e.g., tetrafluoroethylene-perfluoro(propyl vinyl ether)); and combinations thereof.

Useful commercially available thermoplastic fluoropolymers include, for example, those marketed by Dyneon LLC under the trade designations “THV” (e.g., “THV 220”, “THV 400G”, “THV 500G”, “THV 815”, and “THV 610X”), “PVDF”, “PFA”, “HTE”, “ETFE”, and “FEP”; those marketed by Atochem North America, Philadelphia, Pa. under the trade designation “KYNAR” (e.g., “KYNAR 740”); those marketed by Ausimont, USA, Morristown, N.J. under the trade designations “HYLAR” (e.g., “HYLAR 700”) and “HALAR ECTFE”.

The curable matrix described herein may further comprise a thermoplastic polymer blended with the curable polymers described above. Such thermoplastic polymers include polylactones such as, for example, poly(pivalolactone) and poly(caprolactone); polyurethanes such as, for example, those derived from reaction of diisocyanates such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, or 4,4′-diisocyanatodiphenylmethane with linear long-chain diols such as poly(tetramethylene adipate), poly(ethylene adipate), poly(1,4-butylene adipate), poly(ethylene succinate), poly(2,3-butylenesuccinate), polyether diols and the like; polycarbonates such as poly(methane bis(4-phenyl)carbonate), poly(1,1-ether bis(4-phenyl)carbonate), poly(diphenylmethane bis(4-phenyl)carbonate), poly(1,1-cyclohexane bis(4-phenyl)carbonate), or poly(2,2-(bis(4-hydroxyphenyl)propane) carbonate; polysulfones; polyether ether ketones; polyamides such as, for example, poly(4-aminobutyric acid), poly(hexamethylene adipamide), poly(6-aminohexanoic acid), poly(m-xylylene adipamide), poly(p-xylylene sebacamide), poly(metaphenylene isophthalamide), and poly(p-phenylene terephthalamide); polyesters such as, for example, poly(ethylene azelate), poly(ethylene-1,5-naphthalate), poly(ethylene-2,6-naphthalate), poly(1,4-cyclohexane dimethylene terephthalate), poly(ethylene oxybenzoate), poly(para-hydroxy-benzoate), poly(1,4-cyclohexylidene-dimethylene terephthalate) (cis), poly(1,4-cyclohexylidene-dimethylene terephthalate) (trans), polyethylene terephthalate, and polybutylene terephthalate; poly(arylene oxides) such as, for example, poly(2,6-dimethyl-1,4-phenylene oxide) and poly(2,6-diphenyl-1,1phenylene oxide); poly(arylene sulfides) such as, for example, polyphenylene sulfide; polyetherimides; vinyl polymers and their copolymers such as, for example, polyvinyl acetate, polyvinyl alcohol, polyvinyl chloride, polyvinyl butyral, polyvinylidene chloride, and ethylene-vinyl acetate copolymers; acrylic polymers such as, for example, poly(ethyl acrylate), poly(n-butyl acrylate), poly(methyl methacrylate), poly(ethyl methacrylate), poly(n-butyl methacrylate), poly(n-propyl methacrylate), polyacrylamide, polyacrylonitrile, polyacrylic acid, ethylene-ethyl acrylate copolymers, ethylene-acrylic acid copolymers; acrylonitrile copolymers (e.g., poly(acrylonitrile-co-butadiene-co-styrene) and poly(styrene-co-acrylonitrile)); styrenic polymers such as, for example, polystyrene, poly(styrene-co maleic anhydride) polymers and their derivatives, methyl methacrylate-styrene copolymers, and methacrylated butadiene-styrene copolymers; polyolefins such as, for example, polyethylene, polybutylene, polypropylene, chlorinated low density polyethylene, poly(4-methyl-1-pentene); ionomers; poly(epichlorohydrins); polysulfones such as, for example, the reaction product of the sodium salt of 2,2-bis(4-hydroxyphenyl)propane and 4,4′-dichlorodiphenyl sulfone; furan resins such as, for example, poly(furan); cellulose ester plastics such as, for example, cellulose acetate, cellulose acetate butyrate, and cellulose propionate; protein plastics; polyarylene ethers such as, for example, polyphenylene oxide; polyimides; polyvinylidene halides; polycarbonates; aromatic polyketones; polyacetals; polysulfonates; polyester ionomers; and polyolefin ionomers. Copolymers and/or combinations or blends of these aforementioned polymers can also be used.

Block copolymers are generally formed by sequentially polymerizing different monomers or groups of monomers. That is, each block of a block copolymer may be chosen from homopolymers and copolymers. Useful methods for forming block copolymers include anionic, cationic, and free radical polymerization methods.

Useful block copolymers may have any number of segments (i.e., blocks) greater than or equal to two (e.g., di-, tri-, tetra-block copolymers), and may have any form such as, for example, linear, star, comb, or ladder. Generally, at least one segment should have an affinity for the carbon containing nano-material. This segment may be hydrophilic or hydrophobic in nature (e.g., depending on whether the surface of the carbon containing nano-material is modified). As used herein, controlled architecture materials (CAMs), are polymers of varying topology (linear, branched, star, star-branched, combination network), composition (di-, tri-, and multi-block copolymer, random block copolymer, random copolymers, homopolymer, tapered or gradient copolymer, star-branched homo-, random, and block copolymers), and/or functionality (end, site specific, telechelic, multifunctional, macromonomers). Where a CAM is referred to herein to comprise “at least one [monomer] block” it is meant that at least one block of the CAM comprises interpolymerized units derived from the indicated monomer. Such a block may be a homopolymer of the recited monomer or a copolymer that comprises the recited monomer and at least one further monomer.

Functional blocks typically have one or more polar moieties such as, for example, acids (e.g., —CO₂H, —SO₃H, —PO₃H); —OH; —SH; primary, secondary, or tertiary amines; ammonium N-substituted or unsubstituted amides and lactams; N-substituted or unsubstituted thioamides and thiolactams; anhydrides; linear or cyclic ethers and polyethers; isocyanates; cyanates; nitriles; carbamates; ureas; thioureas; heterocyclic amines (e.g., pyridine or imidazole). Useful monomers that may be used to introduce functional blocks are well known and include, for example, acids (e.g., acrylic acid, methacrylic acid, itaconic acid, maleic acid, fumaric acid), acrylates and methacrylates (e.g., 2-hydroxyethyl acrylate), acrylamides and methacrylamides (e.g., acrylamide, t-butyl acrylamide, N,N-(dimethylamino)ethyl acrylamide, N,N-dimethyl-acrylamide, N,N-dimethyl methacrylamide), methacrylamides, N-substituted and N,N-disubstituted acrylamides (e.g., N-ethyl acrylamide, N-hydroxyethyl-acrylamide, N-octyl-acrylamide, N-t-butyl-acrylamide, N,N-dimethyl acrylamide, N,N-diethyl-acrylamide, and N-ethyl-N-dihydroxyethyl-acrylamide), aliphatic amines (e.g., 3-dimethylaminopropyl amine, N,N-dimethylethylenediamine); and heterocyclic-containing monomers (e.g., 2-vinylpyridine, 4-vinylpyridine, 2-(2-aminoethyl)pyridine, 1-(2-aminoethyl)pyrrolidine, 3-aminoquinuclidine, N-vinylpyrrolidone, and N-vinylcaprolactam). Also of interest is the methacrylic anhydride functionality formed via the acid catalyzed deprotection of t-butyl methacrylate moieties as described in pending application U.S. patent application publication No. US 2004/0024130 A 1 (Nelson et al.).

In one embodiment, if any block of the block copolymer comprises ionic or ionizable functions, the monomer bearing the ionic or ionizable functions constitutes from 0.01 to 10% by weight of the total weight of the block comprising the ionic or ionizable functions. Examples of ionic or ionizable function bearing monomers includes, for instance, monomers bearing functional groups such as acids, anhydrides, or amino groups. Monomers having ionic or ionizable functions include, for instance, acrylic acid, methacrylic acid, and maleic anhydride.

In other embodiments, the block copolymer comprises a monomer having a functional group that is labile with heat to produce a functional group that facilitates the dispersion of the carbon containing nano-materials in the curable matrix as described in pending application U.S. Patent Application Publication No. US 2004/0024130 A 1 (Nelson et al.).

Non-functional segments typically have one or more hydrophobic moieties such as for example, aliphatic and aromatic hydrocarbon moieties. Non-functional segments are free of polar moieties. Examples of hydrophobic moieties include those moieties having at least about 4, 8, 12, or even 18 carbon atoms; fluorinated aliphatic and/or fluorinated aromatic hydrocarbon moieties, such as for example, those having at least about 4, 8, 12, or even 18 carbon atoms; and silicone moieties.

Useful monomers for introducing non-functional blocks include, for example: hydrocarbon olefins such as ethylene, propylene, isoprene, styrene, and butadiene; cyclic siloxanes such as decamethylcyclopentasiloxane and decamethyltetrasiloxane; fluorinated olefins such as tetrafluoroethylene, hexafluoropropylene, trifluoroethylene, difluoroethylene, and chlorofluoroethylene.

Other useful monomers include nonfluorinated alkyl acrylates and methacrylates such as butyl acrylate, isooctyl methacrylate lauryl acrylate, stearyl acrylate; fluorinated acrylates such as perfluoroalkylsulfonamidoalkyl acrylates and methacrylates having the formula H₂C═C(R₂)C(O)O—X—N(R)SO₂R_{f} wherein: R_{f} is —C₆F₁₃, —C₄F₉, or —C₃F₇; R is hydrogen, C₁ to C₁₀ alkyl, or C₆-C₁₀ aryl; and X is a divalent connecting group (e.g., C₄F₉SO₂N(CH₃)C₂H₄OC(O)NH(C₆H₄)CH₂C₆H₄NHC(O)OC₂H₄OC(O)CH═CH₂ and C₄F₉SO₂N(CH₃)C₂H₄OC(O)NH(C₆H₄)CH₂C₆H₄NHC(O)OC₂H₄₀C(O)C(CH₃)═CH₂).

Examples of useful block copolymers having non-functional and functional segments include poly(isoprene-block-4-vinylpyridine); poly(isoprene-block-methacrylic acid); poly(isoprene-block-N,N-(dimethylamino)ethyl acrylate); poly(isoprene-block-2-diethylaminostyrene); poly(isoprene-block-glycidyl methacrylate); poly(isoprene-block-2-hydroxyethyl methacrylate); poly(isoprene-block-N-vinylpyrrolidone); poly(isoprene-block-methacrylic anhydride); poly(isoprene-block-(methacrylic anhydride-co-methacrylic acid)); poly(styrene-block-4-vinylpyridine); poly(styrene-block-2-vinylpyridine); poly(styrene-block-acrylic acid); poly(styrene-block-methacrylamide); poly(styrene-block-N-(3-aminopropyl)methacrylamide); poly(styrene-block-N,N-(dimethylamino)ethyl methacrylate); poly(styrene-block-2-diethylaminostyrene); poly(butylene-block-4-vinylpyridine); poly(styrene-block-glycidyl methacrylate); poly(styrene-block-2-hydroxyethyl methacrylate); poly(styrene-block-N-vinylpyrrolidone copolymer); poly(styrene-block-isoprene-block-4-vinylpyridine); poly(styrene-block-isoprene-block-glycidyl methacrylate); poly(styrene-block-isoprene-block-methacrylic acid); poly(styrene-block-isoprene-block-(methacrylic anhydride-co-methacrylic acid)); poly(styrene-block-isoprene-block-methacrylic anhydride); butadiene-block-4-vinylpyridine); poly(butadiene-block-methacrylic acid); poly(butadiene-block-N,N-(dimethylamino)ethyl methacrylate); poly(butadiene-block-2-diethylaminostyrene); poly(butadiene-block-glycidyl methacrylate); poly(butadiene-block-2-hydroxyethyl methacrylate); poly(butadiene-block-N-vinylpyrrolidone); poly(butadiene-block-methacrylic anhydride); poly(butadiene-block-(methacrylic anhydride-co-methacrylic acid); poly(styrene-block-butadiene-block-4-vinylpyridine); poly(styrene-block-butadiene-block-methacrylic acid); poly(styrene-block-butadiene-block-N,N-(dimethylamino)ethyl methacrylate); poly(styrene-block-butadiene-block-2-diethylaminostyrene); poly(styrene-block-butadiene-block-glycidyl methacrylate); poly(styrene-block-butadiene-block-2-hydroxyethyl methacrylate); poly(styrene-block-butadiene-block-N-vinylpyrrolidone); poly(styrene-block-butadiene-block-methacrylic anhydride); poly(styrene-block-butadiene-block-(methacrylic anhydride-co-methacrylic acid)); and hydrogenated forms of poly(butadiene-block-4-vinylpyridine), poly(butadiene-block-methacrylic acid), poly(butadiene-block-N,N-(dimethylamino)ethyl methacrylate), poly(butadiene-block-2-diethylaminostyrene), poly(butadiene-block-glycidyl methacrylate), poly(butadiene-block-2-hydroxyethyl methacrylate), poly(butadiene-block-N-vinylpyrrolidone), poly(butadiene-block-methacrylic anhydride), poly(butadiene-block-(methacrylic anhydride-co-methacrylic acid)), poly(isoprene-block-4-vinylpyridine), poly(isoprene-block-methacrylic acid), poly(isoprene-block-N,N-(dimethylamino)ethyl acrylate), poly(isoprene-block-2-diethylaminostyrene), poly(isoprene-block-glycidyl methacrylate), poly(isoprene-block-2-hydroxyethyl methacrylate), poly(styrene-block-butylene-block-4-vinylpyridine), poly(isoprene-block-N-vinylpyrrolidone), poly(isoprene-block-methacrylic anhydride), poly(isoprene-block-(methacrylic anhydride-co-methacrylic acid)), poly(styrene-block-isoprene-block-glycidyl methacrylate), poly(styrene-block-isoprene-block-methacrylic acid), poly(styrene-block-isoprene-block-methacrylic anhydride-co-methacrylic acid), styrene-block-isoprene-block-methacrylic anhydride, poly(styrene-block-butadiene-block-4-vinylpyridine), poly(styrene-block-butadiene-block-methacrylic acid), poly(styrene-block-butadiene-block-N,N-(dimethylamino)ethyl methacrylate), poly(styrene-block-butadiene-block-2-diethylaminostyrene), poly(styrene-block-butadiene-block-glycidyl methacrylate), poly(styrene-block-butadiene-block-2-hydroxyethyl methacrylate), poly(styrene-block-butadiene-block-N-vinylpyrrolidone), poly(styrene-block-butadiene-block-methacrylic anhydride), and poly(styrene-block-butadiene-block-(methacrylic anhydride-co-methacrylic acid).

Selecting an appropriate block segment for a block copolymer should generally include considering factors such as the chemical identity of the curable matrix (e.g., aliphatic versus aromatic), the multiphase nature (e.g., neat epoxy versus a rubber modified epoxy system), polymer viscosity and/or molecular weight, cured resin glass transition temperature (Tg), and filler load. Each of these considerations may influence the choice of a block segment in, for instance, an AB or ABC multi-block copolymer.

In some embodiments, a monomer for a polar functional block can be chosen according to the affinity of such a monomer, for instance, acid and amine groups in the monomer, towards aromatic rings, such as those present in graphitic nano-material structures. Additionally, the highly hydrophobic nature of these nano-materials may indicate that a choice of highly hydrophobic groups in a non-functional block, such as fluorinated moieties, may be appropriate. It may also be desirable to include functional groups in one of the block segments wherein the functional groups are capable of co-curing with the curable matrix. Examples of co-curable blocks include the use of glycidyl methacrylate-containing polymer segments for use in epoxy resins, and butadiene-containing polymer segments in electron-beam curable systems.

Typically, functional blocks are paired with a corresponding non-functional block. The non-functional block may be immiscible in the final cured matrix of the composite, yet the non-functional block may be chemically similar in nature to the uncured curable matrix. Examples of such selections would include, for example, selecting an aromatic block for use in an aromatic epoxy curable matrix.

The multiphase nature of some curable matrixes, such as the rubber modified phenolic system AF-30 illustrated in some of the examples, can influence segment selection. In a multiphase system, a block segment may be selected depending upon which of the components constitutes the major phase and which the minor phase. For instance, the appropriate block segments may depend upon whether a rubber phase or a thermoset phase are in the majority. A diene-based monomer block may be selected when rubber phases are majority, whereas styrenic monomer blocks may be selected when thermosetting phenolic systems are the majority.

The glass transition temperature of the cured matrix may also influence block selection. In some instances it may not be desirable to include a high Tg glassy block segment in a curable matrix that has a low Tg, particularly where the curable matrix is designed as an elastomeric material.

Resin viscosity, resin molecular weight and filler loading may further influence block design features such as block segment length and overall molecular weight of the block copolymer. For example, in the process of dispersing carbon containing nano-tubes into a high viscosity matrix, it may be desirable to use low molecular weight additives that may be highly mobile in the curable matrix and may be able to transverse a viscous curable matrix under relatively low shear to reach the resin-nano-tube interface. Additionally, the molecular weight may be optimized with respect to the entanglement molecular weight of the block segment so as to not produce block segments which act more as plasticizers than dispersants.

In other embodiments, the compositions described herein may comprise a plurality of carbon containing nano-materials; a thermosetting polymer, including a cured epoxy resin; and a controlled architecture material. The controlled architecture material may be as described herein, including a controlled architecture material comprising at least one styrene block and at least one 4-vinyl pyridine block.

The carbon containing nano-materials used in the present invention are not particularly limited. Carbon nanotubes may be single-walled carbon nanotubes (SWCNT) or double walled carbon nanotubes (DWCNT). The DWCNTs may be obtained by any means, including, for instance, catalytic chemical vapor deposition. Such preparations techniques may give approximately 80% DWCNTs, having a diameter ranging between 1 and 3 nm and a length that can reach 100 μm. The electrical conductivity of such nanotubes may be greater than 25 S/cm when they are pressed into the form of pellets.

Other carbon nanotubes include multi-walled nanotubes (MWCNTs). The MWCNTs may be obtained by vapor deposition in the presence of a supported catalyst, such as described in PCT published patent application WO 03/002456 A 2. MWCNTs so prepared may show, by transmission electron microscopy, that close to 100% of the tubes are MWCNTs. Such MWCNTs may have a diameter ranging between 10 and 50 nm and a length that can attain 70 μm. The electrical conductivity of such MWCNTs may reach greater than 20 S/cm when pressed in the form of pellets.

The SWCNTs, DWCNTs, and MWCNTs may be purified by washing with acid solution (such as sulphuric acid and hydrochloric acid) so as to rid them of residual inorganic and metal impurities. SWCNTs may also be noncovalently modified by encasing the nanotubes within cross-linked, amphiphilic copolymer micelles, such as described by Kang and Taton in Journal of the American Chemical Society, vol. 125, 5650 (2003). In another embodiment, the carbon nanotubes may be surface-functionalized, for instance, as described by Wang, Iqbal, and Mitra in Journal of the American Chemical Society, vol. 128, 95 (2006).

Other carbon containing nano-materials include, for instance, carbon nanofibers. An example of suitable nanofibers include sub-micron VaporGrown Carbon Fibres (s-VGCF) with very small diameters (20-80 nm), high aspect ratio (>100), and a highly graphitic structure (>60%) available as Grupo Antolin Carbon Nanofibres (GANF), from Grupo Antolin, Spain. Alternatively, Pyrograf®-III is available in diameters ranging from 70 and 200 nanometers and a length estimated to be 50-100 microns available from Applied Sciences, Inc. (ASI) located in Cedarville, Ohio.

In yet further embodiments, the vibration damping compositions described herein may further comprise non-carbon containing nano-materials. Such materials include, for instance, silica nano-particles, zirconia nano-particles, and alumina nano-particles, TiO₂, clay, indium tin(oxide), iron oxide, zinc oxide, and combinations thereof.

The compositions described herein may further comprise pigments, flow control additives, anti-oxidants, curative compounds, co-curatives, cure accelerators, inert fillers such as mineral fillers, flame retardants, processing aids such as extrusion aids (including fluoropolymer-based processing aids and lubricants such as mineral oils and waxes), glass bubbles, polymeric bubbles (such as Dualite™ Hollow Composite Microsphere Fillers available from Pierce and Stevens, Corp., Buffalo, N.Y.) and other additives.

Shaped articles may also be formed which comprise a carbon containing nano-material; a curable matrix; and a block copolymer comprising a functional block and a non-functional block, wherein no block is compatible with the curable matrix. In these shaped articles, the carbon containing nano-materials may be dispersed in the curable matrix. In some embodiments, the curable matrix is electrically non-conductive, whereas the composite article itself is electrically conductive. Shaped articles formed from these compositions may have a variety of applications, such as for aerospace parts and for equipment. The preparation of shaped articles, in some instances, may depend on the availability of dispersible conductive filler with a low percolation threshold. The present invention, in some embodiments, may allow for the lowering of filler (e.g., carbon containing nano-material) concentration which in turn may: i) lower the costs associated with such shaped articles, and/or ii) improve the structural properties of the curable matrix for those composites formed with the carbon containing nano-materials and block copolymer compared to the curable matrix shaped in the absence of the carbon containing nano-material and block copolymer (e.g., melt viscosity, transparency, color, and viscoelastic damping).

Shaped articles according to the present invention include, for instance, aerospace components, such as structural components of aircraft, such as wings, wing tips and wing box, fuselage, nose and tail cones, fins, rudders, and the like; and decorative and protective components such as films, tapes, labels, adhesives (which may be a structural adhesive), and the like. In some embodiments, the compositions described herein allow for efficient and/or uniform dispersion of carbon containing nano-materials. This efficient dispersion may give rise to favorable properties, such as tensile strength, modulus improvements, flexibility, electrical conductivity, thermal conductivity, and viscoelastic vibration damping. Such improvements may have particular application in the fabrication of aircraft parts, for example, allowing for dissipation of thermal, electrical, and vibrational energy. The articles may be in any form, for instance, in the form of a molded composite or a film.

The compositions according to the present description may be formed, for instance, by high shear mixing. The preparation may include first preparing a dispersion of carbon containing nano-materials in solvent with block copolymers described herein. The solvent may then be removed, leaving a residue containing the block copolymers and containing nano-materials. This residue may then be added to a curable matrix and then exposed to high shear mixing. Alternatively, the three components, block copolymer, curable matrix, and carbon containing nano-materials, may be added together and then exposed to high shear mixing. In yet another embodiment, a dispersion of carbon containing nano-materials in solvent with block copolymers may be directly mixed with a resin under high shear conditions. The solvent may then optionally be removed from the composition.

The compositions may also be prepared by other mixing techniques, including melt compounding and ultrasonic mixing.

In some embodiments of the present compositions, the containing nano-materials are dispersed in the curable matrix. In some embodiments of these dispersed compositions, the reagglomeration time of the carbon containing nano-materials is 50 hours or more, 100 hours or more, or even 1000 hours or more. Some of the compositions have a re-agglomeration time of months or even years.

In yet further embodiments, the present invention relates to cured vibration damping compositions and multi-layer articles comprising cured vibration damping compositions, wherein the curable matrix is cured, for instance, by heat or by exposing the composition to actinic radiation.

In some embodiments, the cured compositions described herein have a tan δ value that is at least 10% higher than a comparable cured composition containing the cured matrix that lacks the carbon containing nano-materials and block copolymer as described herein. In other embodiments, the tan δ value of the cured compositions described herein is increased by 20% or more, 25% or more, 35% or more, or even 50% or more when compared to a cured composition containing the cured matrix that lacks the carbon containing nano-materials and block copolymer as described herein. The tan δ value is measured at the same temperature and over the same frequency range for both the embodiments of the present description and the comparable cured compositions. The range of frequencies at which the tan δ is measured may be from 1 to 20,000 Hz, and the operational temperature may range, for instance, from −50 to about 100° C.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

### General Procedure for Dynamic Mechanical Thermal Analysis (DMTA)

Room temperature DMTA testing was performed on a DMTA 3 from Rheometrics (Piscataway, N.J.). A 3-point bend fixture held the samples, which had dimensions of approximately 8 mm×40 mm×1 mm. The samples were supported on a 26 mm frame in the three-point bend configuration. A small and constant initial stress was placed on the samples prior to oscillatory measurements over the frequency range of 10-100 radians/s. The elastic (E′) and loss (E″) modulii were calculated based on the response of the sample and the sample geometry. The loss tangent (tan δ) was calculated from the ratio of the loss to elastic modulii (tan δ=E″/E′).

Low temperature DMTA analysis using a TA instruments Q-series Q800 (New Castle, Del.), was performed in tension mode on samples which had dimensions of approximately 20 mm×9 mm×0.44 mm.

Temperature sweep tests (i.e., DMTA over a range of temperatures at a set frequency, as illustrated in FIG. 6) were performed on an ARES Rheometer (TA Instruments) using the rectangular torsion fixture with approximate dimensions of 30 mm×8 mm×1 mm. A strain of 0.5% was applied to the sample at a frequency of 2.5 Hz. Data was collected approximately every 2° C. after a 60 second equilibration period at each temperature over a range of −60° C. to about 175° C.

### General Solution Pre-compounding Procedure

Mixtures of AF-30, carbon nanotubes (CNTs) and additives were created by suspending AF-30 in 100 ml of THF according to the quantities in Table 1. This suspension was stirred at room temperature for 1 hr, after which the solvent was removed under vacuum (50 mm Hg). The resulting rubbery material was then processed according to the General Procedure for Microcompounding.

### General Procedure for Microcompounding

Batch compounding and extrusion was carried out using a 15-mL conical twin-screw micro-compounder, available under the trade designation “DSM RESEARCH 15 ml MICRO-COMPOUNDER” from DSM Xplore, The Netherlands. All six controlled heating zones for the micro-compounder were operated according to settings outlined in Table 2. During the material feeding and mixing process, the exit valve was set to allow material to flow through the recirculating channel in order to control both the mix time and the batch formulation. Polymer resin pellets and/or the pre-blended polymer/single-walled carbon nanotube mixtures were added to the micro-compounder using the manually operated feed hopper, with a total charge size of 15.0 g. After the materials were fed, the manual feed hopper was removed, and the plugging insert was inserted into the feed port. Once the feed port was plugged, the sample was blended in the recirculating compounder for 3.0 minutes. Midway through the mixing cycle, the product melt temperature and force were recorded for each sample. After the 3-minute mix time, the exit valve was opened in order to extrude a strand of the compounded sample, which was collected for further analysis.

### General Procedure for Loss Factor Measurement

Samples of various composites were tested by molding films of the composites into rectangular pieces (approximately 15 mm×40 mm×2 mm). Cured samples of these parts were prepared by heating the composites at 120° C. and under a pressure of 100 psi (690 kPa) for 1 hr. The short edge of these structures was then placed in a clamp and the base of the clamp attached to a mechanical shaker. The tip of these structures was painted with white paint to provide reflection and allow for adequate detection by a photonic sensor (MTI model 2000 photonic sensor with a 2125R sensor head, MTI Instruments, Albany, N.Y.). An accelerometer (Kistler model RC200, Kistler Instrument Corporation, Amherst, N.Y.) was mounted on the support base. Data was collected and a transfer function between the base input and tip output calculated with a frequency analyzer (HP model 35670, Agilent Technologies, Inc, Santa Clara, Calif.). The mechanical shaker was excited by swept sine that was generated by the frequency analyzer. Loss factor, defined as the ratio of the average damping per radian to the total strain energy in the test system, as described in Noise and Vibration Control Engineering, L. L. Beranek and I. L. Ver, John Wiley and Sons, Inc, 1992, p. 455, was calculated by the well-known half power point method using the transfer function described above. For a detailed explanation of this method, see Shock and Vibration Handbook, C. M. Harris and C. E. Crede, McGraw Hill, 2^{nd} edition, pp. 2-15.

### Molecular Weight and Polydispersity

Average molecular weight and polydispersity were determined by Gel Permeation Chromatography (GPC) analysis. Approximately 25 mg of a sample were dissolved in 10 milliliters (mL) of THF to form a mixture. The mixture was filtered using a 0.2-micron pore size polytetrafluoroethylene syringe filter. Then, about 150 microliters of the filtered solution were injected into a gel-packed column 25 cm long by 1 cm diameter available under the trade designation “PLGEL-MIXED B” from PolymerLabs, Amherst, Mass. that was part of a GPC system equipped with an autosampler and a pump. The GPC system was operated at room temperature using THF eluent that moved at a flow rate of approximately 0.95 mL/minute. A refractive index detector was used to detect changes in concentration. Number average molecular weight (Mₙ) and polydispersity index (PDI) calculations were calibrated using narrow polydispersity polystyrene controls ranging in molecular weight from 580 to 7.5×10⁶ g/mole. The actual calculations were made with software (available under the trade designation “CALIBER” from Polymer Labs, Amherst, Mass.).

The following abbreviations are used throughout the Examples:

| Abbreviation | Description |
|---|---|
| P(S-4-VP) | Poly(styrene-b-4-vinyl pyridine) block copolymer (Mₙ = 3.7 × 10⁴; PDI = 2.3; |
| | PS mol % = 95.2; 4-VP mol % = 4.8) was synthesized according |
| | to methods described in U.S. Pat. No. 6,903,173 and references |
| | therein. |
| THF | Tetrahydrofuran |
| AF-555 | 3M ™ Scotch-Weld ™ Bonding Film AF 555 is an epoxy-based film |
| | adhesive, supplied with a protective liner. Designed for curing at |
| | temperatures of 225° F. (107° C.) to 350° F. (177° C.) at 50 to 100 psi (345 to |
| | 690 kPa), available from 3M Company, St. Paul, MN. |
| AF-30 | 3M ™ Scotch-Weld ™ Bonding Film AF 30 is an unsupported nitrile- |
| | phenolic type film adhesive, supplied with a protective liner. Designed |
| | for curing at temperatures of 225° F. (107° C.) to 350° F. (177° C.) at 50 to |
| | 100 psi (345 to 690 kPa), available from 3M Company. |
| MWCNT 1 | Multi-wall carbon nanotubes, with a 8-15 nm outer diameter and |
| | 10-50 □m length, available from Cheap Tubes Inc. Brattleboro, VT. |
| | Nanotubes are 90% purity by weight. Nanotubes were used without any |
| | further purification. |
| MWCNT 2 | Multi-wall carbon nanotubes, with a 30-50 nm outer diameter and |
| | 10-20 □m length, available from Cheap Tubes Inc. Brattleboro, VT. |
| | Nanotubes are 90% purity by weight. Nanotubes were used without any |
| | further purification. |
| SWCNT 1 | Single-wall carbon nanotubes (95% purity by weight), available from |
| | Cheap Tubes Inc. Brattleboro, VT. Nanotubes were used without any |
| | further purification. |
| CNF 1 | Carbon nanofibers, GANF1, with a 20-80 nm diameter and 30 □m |
| | length, available from Grupo Antolin Ingeneria S.A. Ctra. Madrid-Irun, |
| | Burgos Spain. Nanofibers were used without any further purification. |

### Comparative Examples 1-4

### CE1-CE4

Mixtures of AF-555 and CNTs were formed according to Table 1 and were mixed according to the General Procedure for Microcompounding. Contents of the microcompounder were mixed according to the processing conditions shown in Table 2. DMTA samples were prepared by curing the films at 120° C. for 24 hrs.

TABLE 1
Experimental Formulations

| | AF- | AF- | MWNT | MWNT | SWNT | | CNF |
|---|---|---|---|---|---|---|---|
| | 555 | 30 | 1 | 2 | 1 | P(S-4-VP) | 1 |
| Example | (g) | (g) | (g) | (g) | (g) | (g) | (g) |
| CE1 | 19 | | | | | | |
| CE2 | 19 | | | 1 | | | |
| CE3 | 19 | | 1 | | | | |
| CE4 | 19 | | | | 1 | | |
| CE5 | | 12 | | | | | |
| CE6 | | 12 | 0.6 | | | | |
| CE7 | | 12 | | 0.6 | | | |
| CE8 | 19 | | | | | | 1 |
| EX1 | 18 | | | 1 | | 1 | |
| EX2 | 18 | | 1 | | | 1 | |
| EX3 | 18 | | | | 1 | 1 | |
| EX4 | | 12 | 0.6 | | | 0.6 | |
| EX5 | | 12 | 0.3 | 0.3 | | 1 | |
| EX6 | | 12 | 0.3 | 0.3 | | 0.3 | |
| EX7 | | 12 | 0.3 | 0.4 | | 0.7 | |
| EX8 | | 12.5 | 0.3 | 0.3 | 0.1 | 0.7 | |
| EX9 | | 12.5 | | 0.25 | | 0.25 | |
| EX10 | | 12.5 | | 0.44 | | 0.44 | |
| EX11 | | 12 | | 0.6 | | 0.6 | |
| EX12 | 18 | | | | | 1 | 1 |

### Comparative Examples 5-7

### CE5-CE7

Blends of AF-30 and CNTs were prepared in quantities as listed in Table 1. This blend of materials was formed according to the General Solution Pre-compounding Procedure. This blend of materials was added to the barrel of the microcompounder and processed according to the General Procedure for Microcompounding. Contents of the microcompounder were mixed according to the processing conditions shown in Table 2. DMTA samples were prepared by curing the composite at 120° C. and 100 psi for 1 hr.

TABLE 2
Microcompounding Conditions

| | Screw | | Melt | Barrel Temperature (° C.) | | | | | |
|---|---|---|---|---|---|---|---|---|---|
| | Speed | Force | Temp | Top | Top | Center | Center | Bottom | Bottom |
| Example | (rpm) | (N) | (° C.) | (Back) | (Front) | (Back) | (Front) | (Back) | (Front) |
| CE1 | 245 | 713 | 100.1 | 99.8 | 100.1 | 101.1 | 102.1 | 100.3 | 99.1 |
| CE2 | 245 | 687 | 100.1 | 99.8 | 101.1 | 101.9 | 103.1 | 100.3 | 99.1 |
| CE3 | 245 | 713 | 101.3 | 100.1 | 99.8 | 100.1 | 101.1 | 102.1 | 100.7 |
| CE4 | 245 | 687 | 100.5 | 100.1 | 99.8 | 101.1 | 101.9 | 103.1 | 100.6 |
| CE5 | 200 | 7270 | 95.2 | 95.8 | 96.1 | 96.8 | 100.9 | 95.5 | 95.5 |
| CE6 | 200 | 6900 | 95.5 | 95.3 | 96.1 | 96.8 | 100.8 | 95.5 | 95.4 |
| CE7 | 205 | 7000 | 95.5 | 95.4 | 96.3 | 96.8 | 100.9 | 95.5 | 95.9 |
| CE8 | 245 | 713 | 100.1 | 99.8 | 100.1 | 101.1 | 102.1 | 100.3 | 99.1 |
| EX1 | 245 | 687 | 100.1 | 99.8 | 101.1 | 101.9 | 103.1 | 100.3 | 99.1 |
| EX2 | 245 | 687 | 100.9 | 99.8 | 101.0 | 102.2 | 103.4 | 100.3 | 99.1 |
| EX3 | 245 | 687 | 100.1 | 99.8 | 101.1 | 101.9 | 103.1 | 100.3 | 99.1 |
| EX4 | 236 | 7032 | 92.1 | 95.5 | 95.6 | 97.6 | 99.7 | 99.5 | 99.7 |
| EX5 | 180 | 6620 | 92.8 | 95.3 | 95.4 | 99.4 | 100.3 | 95.1 | 95.2 |
| EX6 | 200 | 7000 | 94.3 | 95.3 | 95.5 | 102.8 | 103.9 | 96.6 | 95.5 |
| EX7 | 200 | 6961 | 94.3 | 95.3 | 95.2 | 101.8 | 103.9 | 96.1 | 95.4 |
| EX8 | 180 | 7410 | 92.6 | 95.2 | 95.3 | 99.1 | 100.2 | 95.3 | 95.2 |
| EX9 | 180 | 5829 | 88.1 | 95.7 | 95.6 | 95.2 | 95.5 | 94.0 | 93.9 |
| EX10 | 231 | 5061 | 94.2 | 96.1 | 96.3 | 98.4 | 99.1 | 96.9 | 96.6 |
| EX11 | 180 | 7440 | 92.6 | 95.1 | 95.6 | 99.2 | 100.3 | 95.5 | 95.7 |
| EX12 | 245 | 700 | 100.3 | 99.5 | 100.4 | 101.5 | 102.4 | 100.6 | 99.6 |

### Examples 1-3

### EX1-EX3

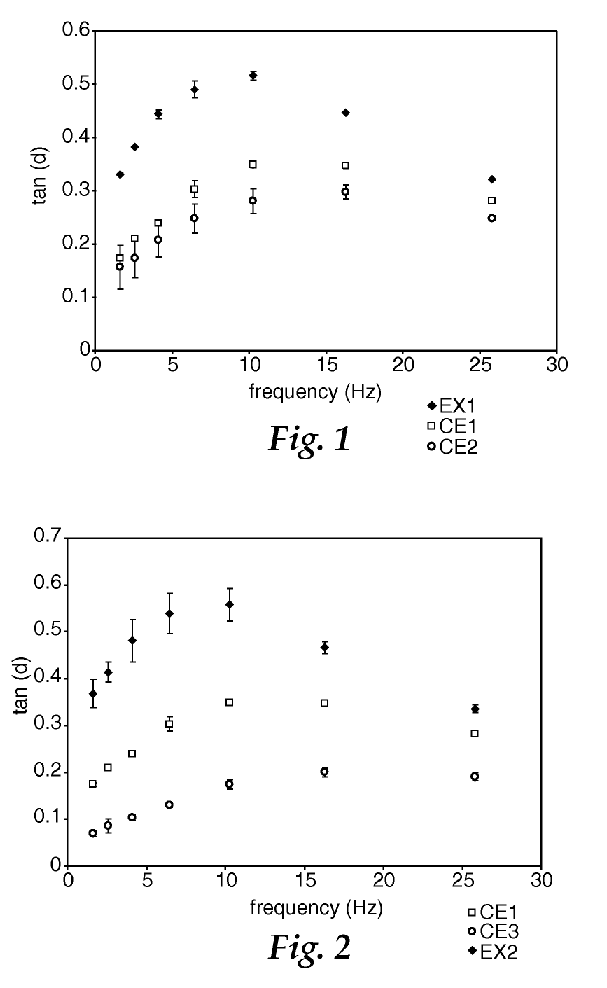

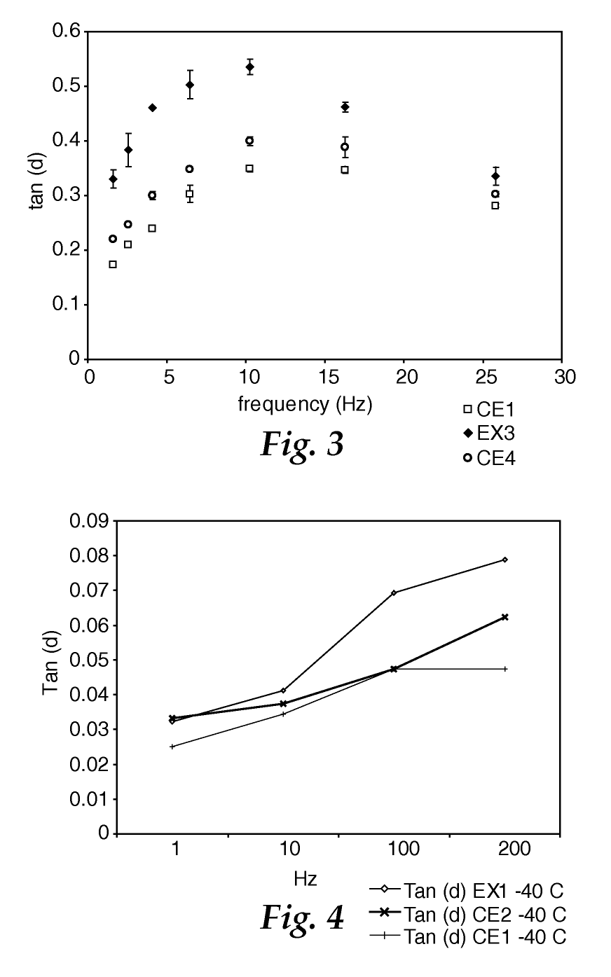

Various mixtures of AF-555, P(S-4-VP) and CNTs were formed according to Table 1 and mixed according to the General Procedure for Microcompounding. Contents of the microcompounder were mixed according to the processing conditions shown in Table 2. DMTA samples were prepared by curing the composites by procedures at 120° C. for 24 hrs and the results of these tests can be seen in FIGS. 1-5. FIGS. 1-3 display the importance of block copolymer inclusion on damping performance over a broad frequency range as measured by DMTA. Samples containing P(S-4-VP) (EX1-EX3) repeatedly display higher damping ratios (Tan δ) as compared to the base AF-555 film (CE1) and MWCNT/AF-555 compounds. Interestingly, in some cases nanotube inclusion into the AF-555 system can have a negative impact on Tan δ (eg. FIG. 2). FIGS. 1-3 also reveal that the improvements in damping ratio seem to be independent of the type of nanotube used, offering the possibility of great formulation breadth and cost advantages as MWCNT's are significantly less expensive than SWCNT's.

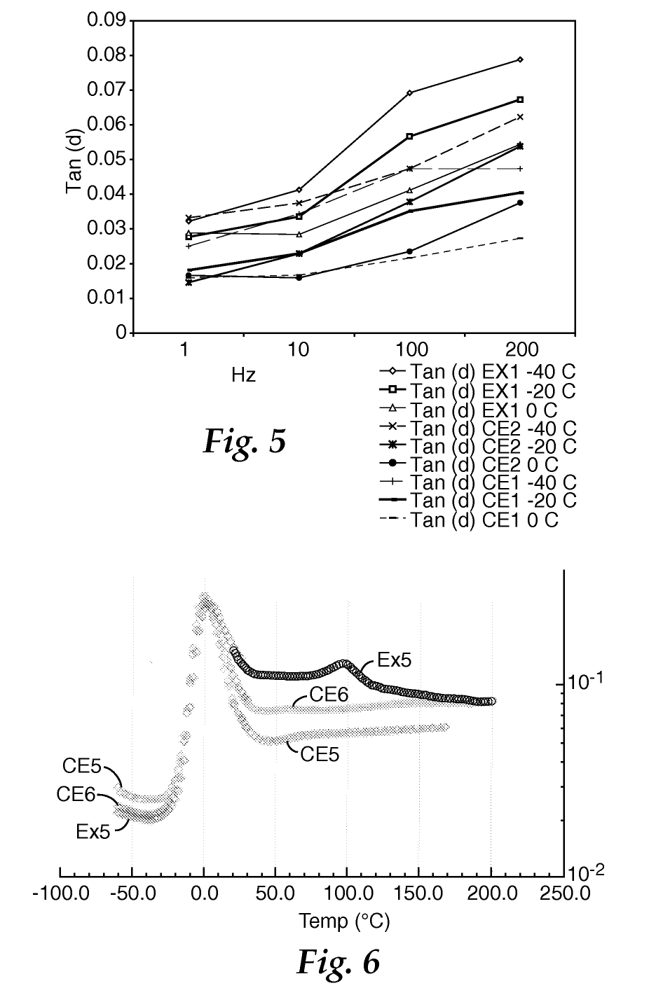

FIGS. 4 and 5 display low temperature DMTA data for EX1, which again illustrates the improvement in damping ratio enabled by use of P(S-4-VP) and suggests this trend is present across a broad temperature range.

### Examples 4-11

### EX4-EX11

Various mixtures of AF-30, P(S-4-VP) and CNTs were formed according to Table 1. This blend of materials was formed according to the General Solution Pre-compounding Procedure and subsequently processed to the General Procedure for Microcompounding. Contents of the microcompounder were mixed according to the processing conditions shown in Table 2. DMTA samples were prepared by curing the composites by procedures at 120° C. and 100 psi for 1 hr and the results of these tests can be seen in FIG. 6 and Table 3. FIG. 6 demonstrates the importance of block copolymer inclusion. Samples containing P(S-4-VP) (EX4-EX11) repeatedly display higher damping ratios (Tan δ) as compared to the base AF-30 film (CE5) and MWCNT/AF30 compounds across a broad frequency range.

Additionally, samples of EX11 and EX4 were prepared and tested according to the General Procedure for Loss Factor Measurement after being cured at 120° C. and 100 psi for 1 hr. The results of these tests can be seen in Table 4 in comparison to AF-30 base film (CE5) and AF-30/MWNT2 (CE7) and AF-30/MWNT1 composites (CE6).

TABLE 3
Effect of P(S-4-VP) Inclusion on Nanotube Damping Performance for Various
MWCNT/SWCNT mixtures in AF-30

| Frequency | Tan δ | | | | | | |
|---|---|---|---|---|---|---|---|
| (Hz) | EX6 | EX5 | EX7 | EX8 | EX9 | EX10 | CE5 |
| 16 | 0.346623 | 0.36756 | 0.41013 | 0.301838 | 0.34452 | 0.300253 | 0.207687 |
| 25 | 0.520753 | 0.61112 | 0.48927 | 0.513445 | 0.467935 | 0.452993 | 0.393343 |

TABLE 4
Loss Factor Measurements^{a}

| | Resonant | Percent Critical |
|---|---|---|
| Example | Frequency (Hz) | Damping |
| CE5 | 207 | 8.5 |
| CE7 | 129 | 17.3 |
| EX11 | 149 | 24.7 |
| EX4 | 121 | 20.7 |
| CE6 | 115 | 23.5 |

^{a}The data presented in Table 3 represents a single measured value for the samples.

### Comparative Examples 8

### CE8

A mixture of AF-555 and nanofibers was formed according to Table 1 and was mixed according to the General Procedure for Microcompounding. Contents of the microcompounder were mixed according to the general processing conditions shown in Table 2. DMTA samples were prepared by curing the films at 120° C. for 24 hrs.

### Example 12

A Mixture of AF-555, P(S-4-VP) and CNF1 was formed according to Table 1 and mixed according to the General Procedure for Microcompounding. Contents of the microcompounder were mixed according to the general processing conditions shown in Table 2. DMTA samples were prepared by curing the composites by procedures at 120° C. for 24 hrs and the results of these tests can be seen in FIG. 7. FIG. 7 demonstrates the importance of carbon nanofiber and block copolymer inclusion on damping performance over a broad frequency range as measured by DMTA. Samples containing P(S-4-VP) (EX12) display higher damping ratios (Tan δ) as compared to the base AF-555 film (CE1) and CNF1/AF555 (CE8) compounds.

Various modifications and alterations of this invention will become apparent to those skilled in the art without departing from the scope and principles of this invention, and it should be understood that this invention is not to be unduly limited to the illustrative embodiments set forth hereinabove.

We claim:

1. A vibration damping composition comprising:
a) a carbon containing nano-material;
b) a curable matrix; and
c) a block copolymer comprising a functional block and a non-functional block, wherein no block is compatible with the curable matrix.

2. The composition of claim 1 wherein the carbon containing nano-material is selected from the group consisting of a carbon nano-tube, a carbon nano-fiber, and combinations thereof.

3. The composition of claim 2 wherein the carbon nano-tube is a multi-walled carbon nano-tube.

4. The composition of claim 2 wherein the carbon nano-tube is a surface-functionalized carbon nano-tube.

5. The composition of claim 1 wherein the non-functional block is selected from the group consisting of isoprene, styrene, and butadiene and the functional block is selected from the group consisting of 4-vinyl pyridine, N,N-(dimethylamino)ethyl methacrylate, methacrylic acid and acrylic acid.

6. The composition of claim 1, wherein the amphiphilic block copolymer comprises three or more blocks.

7. The composition of claim 1 wherein the curable matrix is selected from the group consisting of thermoset polymers and pressure sensitive adhesives.

8. The composition of claim 7 wherein the thermoset polymer is selected from the group consisting of a phenolic based resin and an epoxy based resin.

9. The composition of claim 7 wherein the curable matrix is selected from the group consisting of a poly(methacrylic acid), a phenolic polymer, a polyhexamethyleneadipamide polymer, a polycaprolactam, a poly(methyl methacrylate), a polyphenylquinoxaline, a polyoxymethylene a poly(vinyl chloride), a poly(vinyl butyral), a polysulfone, a polyether-based polyurethane, a polybutadiene-based polyurethane, a poly(acrylonitrile-butadiene-styrene) polymer, a poly(vinylidene fluoride), a polydimethylsiloxane, epoxies, polyimides, bismaleimides, phenoxies, and combinations thereof.

10. The composition of claim 1 wherein the curable matrix comprises a thermoset polymer selected from the group consisting of an amino thermoset, a furan thermoset, a polyester thermoset, a phenolic thermoset, an epoxy thermoset, a polyurethane thermoset, a silicone thermoset, and an allyl thermoset.

11. The composition of claim 7 wherein the curable matrix further comprises hollow glass micro-spheres.

12. The composition of claim 7 wherein the curable matrix comprises an epoxy containing material (a mixture of polyepoxide resins comprising from cycloaliphatic-containing polyepoxide resin and aromatic polyepoxide resin) comprising units derived from a first monomer selected from the group consisting of butanediol diglycidyl ether, resorcinol diglycidyl ether, bisphenol A diglycidyl ether, and diglycidyl ether of propylene glycol, dicyclopentadiene based epoxide and a second monomer selected from the group consisting of diethylenetriamine, triethylenetetramine, meta-phenylene diamine, tri(2-ethylhexoate) salt of tri(dimethylaminomethyl)phenol, propanediamine, hexanediamine, and dodecanediamine.

13. The composition of claim 1 wherein the composition has a tan δ value that is at least 10% higher than the tan δ of a curable matrix containing no nano-material and CAMs.

14. The composition of claim 1 wherein the carbon containing nano-material is present in an amount of from 0.1 to 10 wt % based on the total weight of the composition.

15. The composition of claim 2 wherein the carbon containing nano-material is present in an amount of from 0.1 to 10 wt % based on the total weight of the composition.

16. The composition of claim 1 further comprising non-carbon containing nano-material.

17. The composition of claim 16 wherein the non-carbon containing nano-material is selected from the group consisting of silica nano-particles, noble metal nanoparticles, zirconia nano-particles, and alumina nano-particles, TiO₂, clay, indium tin(oxide), iron oxide, zinc oxide, and combinations thereof.

18. A multi-layer article comprising a dampening layer that comprises
a) a carbon containing nano-material;
b) a curable matrix; and
c) a block copolymer comprising a functional block and a non-functional block, wherein no block is compatible with the curable matrix.

19. The multi-layer article of claim 18 further comprising a surface layer that comprises a thermoset.

20. The multi-layer article of claim 19 wherein the surface layer further comprises a carbon fiber.

21. A method for increasing the material dampening of a polymer composition comprising mixing a curable matrix, a carbon containing nano-material, and a block copolymer comprising a functional block and a non-functional block.

22. The method of claim 21 wherein the block copolymer comprises a functional block and a non-functional block, further wherein no block is compatible with the polymer.

23. The method of claim 22 wherein the curable matrix is selected from the group consisting of polymers for forming vibration damping compositions.

24. The method of claim 22 wherein the curable matrix is selected from the group consisting of adhesive polymers.

25. A vibration damping composition comprising:
a) a carbon containing nano-material;
b) a cured matrix; and
c) a block copolymer comprising a functional block and a non-functional block, wherein no block is compatible with the cured matrix.

26. A sound dampening article for an enclosed acoustic space comprising the composition of claim 25.

27. A multi-layer article comprising a dampening layer that comprises
a) a carbon containing nano-material;
b) a cured matrix; and
c) a block copolymer comprising a functional block and a non-functional block, wherein no block is compatible with the cured matrix.

28. The multi-layer article of claim 27 wherein the dampening layer is the outermost layer of the article.

29. The multi-layer article of claim 27 wherein the dampening layer is the innermost layer of the article.
